(19) United States
(12) Patent Application Publication
(10) Pub. No.: US 2011/0025524 A1
(43) Pub. Date: Feb. 3, 2011

(54) SIGNAL CLOTHING

(75) Inventors: James LEE, Taipei (TW); Hong Hsu HUANG, Taipei (TW)

Correspondence Address: Skaar Ulbrich Macari, P.A., 601 Carlson Parkway, Suite 1050, Minneapolis, MN, 55305, US

(73) Assignee: TEX-RAY INDUSTRIAL CO., LTD., Taipei (TW)

(21) Appl. No.: 12/568,407

(22) Filed: Sep. 28, 2009

(30) Foreign Application Priority Data
Jul. 29, 2009 (TW) 098125494

(51) Int. Cl. H04L 7/00; A41D 1/00

(52) U.S. Cl. 340/825.2; 2/69; 455/90.1

(57) ABSTRACT

An article of signal clothing is provided. The signal clothing may comprise a clothing body, a signal generating unit, and a transceiving unit. The signal generating unit is disposed on the clothing body and configured to generate a signal periodically. The transfer unit is disposed on the clothing body, electrically connected to the signal generating unit, and configured to transmit a synchronization signal periodically in response to the signal generated periodically by the signal generating unit so that a corresponding signal clothing generates a corresponding signal after the receipt of the synchronization signal and generates the corresponding signal periodically in a operating frequency after generating the corresponding signal.

### PRIORITY

This application claims priority benefit of Taiwan Patent Application No. 098125494,filed on Jul. 29, 2009, the disclosure of which is incorporated by reference herein in its entirety.

### FIELD

The present invention relates to a signal clothing. More particularly, the signal clothing of the present invention is capable of interacting with other signal clothing nearby to give out signals synchronously.

### BACKGROUND

In recent years, with improvement on quality of people's life, more and more people are enthusiastic about attending activities held in big stadiums, such as sporting events and music concerts. During a sporting event, fans often cheer on their favorite team with noisemaking devices such as horns. Similarly, fans often swing a flashing device, such as a glow stick or a light stick, in a music concert by following the music tempo.

Nowadays, noisemaking devices and flashing devices have to be manipulated by individuals, so sound signals emitted by the noisemaking devices have distinct starting time. Sound signals emitted by noisemaking devices having distinct starting times may produce disjointed noises. Similarly, flashing signals generated by flashing devices are not synchronized because the flashing devices are controlled by undirected individuals. As a consequence, noisemaking devices and flashing devices fail to provide expected practical values and effects.

Accordingly, there is a need for devices that can be synchronized with each other easily so that synchronized sound and/or flashing signals can be easily and quickly obtained when the devices are placed closely.

### SUMMARY

One objective of certain embodiments of the present invention is to provide a signal clothing, which is capable of (1) generating a signal periodically and (2) transmitting a synchronization signal periodically in response to the signal that is generated periodically. If a corresponding signal clothing exists nearby, the corresponding signal clothing will generate a corresponding signal after receiving the synchronization signal. Through the generation of audio or flashing signals by the signal clothing of the present invention, the problem that conventional devices fail to generate synchronous audio/light signals is overcome.

According to certain embodiments, signal clothing of the present invention comprises a clothing body, a signal generating unit, and a transceiving unit. The signal generating unit is disposed on the clothing body and configured to generate a signal periodically. The transceiving unit is disposed on the clothing body and electrically connected to the signal generating unit. The transceiving unit is configured to transmit a synchronization signal periodically in response to the signal periodically generated by the signal generating unit so that a corresponding signal clothing generates a corresponding signal synchronously after receiving the synchronization signal and then generates the corresponding signal periodically in an operating frequency.

Another objective of particular embodiments of the present invention is to provide a signal clothing, which is capable of receiving a synchronous signal from a corresponding signal clothing and generating a signal synchronously after receiving the synchronization signal. Through the generation of audio or flashing signals by the signal clothing of the present invention, the problem that conventional devices fail to generate synchronous audio/light signals is overcome.

According to certain embodiments, the signal clothing of the present invention comprises a clothing body, a signal generating unit, and a transceiving unit. The transceiving unit is disposed on the clothing body and configured to receive a synchronization signal from a corresponding signal clothing. The signal generating unit is disposed on the clothing body and electrically connected to the transceiving unit. The signal generating unit is configured to generate a signal synchronously according to the synchronization signal. The signal generating unit is further configured to generate the signal periodically in an operating frequency after generating the signal.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 depicts a schematic view of a signal clothing in a first example embodiment of the present invention;

FIGS. 2A-2F depict examples of the first embodiment of the present invention;

FIG. 3 depicts a schematic view of a signal clothing in a second and a third example embodiment of the present invention; and

FIG. 4 is a schematic view of a signal clothing in a fourth example embodiment of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

The present invention provides a signal clothing which is capable of wirelessly transmitting and receiving signals (e.g., Bluetooth signals, infrared-ray signals, and other wireless radio wave signals) in order to synchronize or to be synchronized with other signal clothing nearby. By doing so, a special visual and/or audio effect can be achieved. In a scenario that a sport game, vocal concert or music concert is held in a stadium, fans can wear signal clothing of the present invention and signal clothing worn by fans can generate audio or flashing signals synchronously because fans usually sit or stand closely.

The following description is provided to enable those of ordinary skill in the art to practice and use the present invention and to describe example embodiments of the present invention and requirements thereof. Various variations of these embodiments as well as general principles and features described herein will be readily appreciated by those of ordinary skill in the art. Therefore, these embodiments are not intended to limit the present invention, and scope of the present invention shall be interpreted in the broadest sense according to the principals and features described herein.

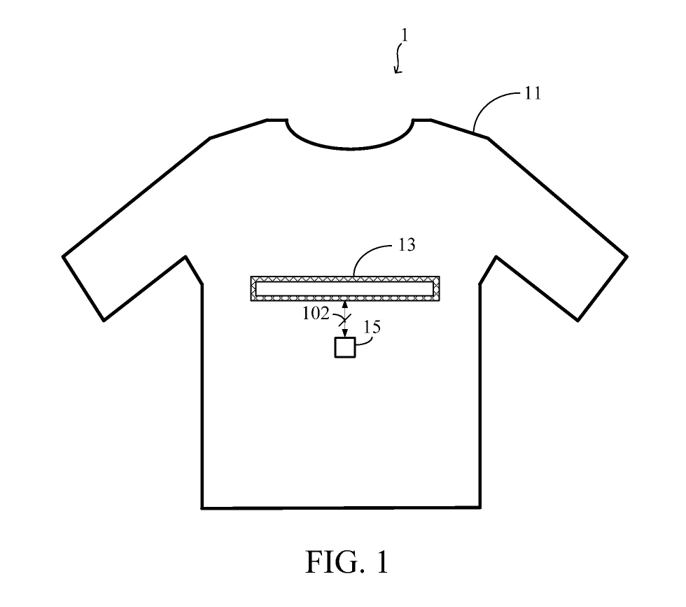

A first example embodiment of the present invention is a signal clothing 1, a schematic view of which is depicted in FIG. 1. The signal clothing 1 may be worn on an object, e.g. a user, a balloon, and a handheld article. To be more specific, the signal clothing 1 comprises a clothing body 11, a signal generating unit 13, and a transceiving unit 15. The signal generating unit 13 is disposed on the clothing body 11 and configured to generate a signal periodically. It should be noted that the signal generating unit 13 may be disposed at any position on the clothing body 11. For example, when the clothing body 11 is worn on a user, the signal generating unit 13 may be disposed at an area corresponding to the chest or arm of the user. In other words, the position to dispose the signal generating unit 13 on the clothing body 11 is not a limited factor in the present invention.

The transceiving unit 15 is disposed on the clothing body 11 and electrically connected to the signal generating unit 13. While the signal is periodically generated by the signal generating unit 13, the transceiving unit 15 transmits a synchronization signal periodically in response to the signal periodically generated by the signal generating unit 13. If a first corresponding signal clothing (i.e., another signal clothing which is essentially the same as the signal clothing 1) is within a signal coverage of the signal clothing 1, then the first corresponding signal clothing will generate a corresponding signal synchronously after receiving the synchronization signal transmitted by the signal clothing 1. Thereafter, the first corresponding signal clothing will generate the corresponding signal periodically in an operating frequency.

Furthermore, the signal generating unit 13 may be a light source device and in that case the signal generated by the signal generating unit 13 is a flashing signal generated by the light source device. While the signal generating unit 13 periodically generates flashing signals, the transceiving unit 15 transmits synchronization signals periodically in response to the flashing signals periodically generated by the signal generating unit 13, wherein the synchronization signals are transmitted in a wireless broadcast way. It is noted that the period in which the transceiving unit 15 transmits the synchronization signal may be a multiple of the period in which the signal generating unit 13 generates the flashing signal. Alternatively, the signal generating unit 13 may be an audio source device, in that case the signal generated by the signal generating unit 13 is an audio signal generated by the audio source device and the transceiving unit 15 transmits the synchronization signal in response to the audio signal periodically generated by the signal generating unit 13.

Furthermore, if the signal clothing 1 is within a signal coverage of a second corresponding signal clothing (i.e., yet another signal clothing which is essentially the same as, or corresponds to, the signal clothing 1), then the transceiving unit 15 of the signal clothing 1 receives another synchronization signal from the second corresponding signal clothing. Thereafter, the signal generating unit 13 generates a signal synchronously according to another synchronization signal and then generates the signal in an operating frequency. Moreover, upon receiving the another synchronization signal from the second corresponding signal clothing, the transceiving unit 15 of the signal clothing 1 transmits a triggering signal 102 to the signal generating unit 13 immediately so that the signal generating unit 13 generates the signal immediately in response to the triggering signal 102. When the second corresponding signal clothing transmits the another synchronization signal periodically in response to the signal generated by itself, the signal clothing 1 will generate the signal periodically according to the another synchronization signal periodically generated by the second corresponding signal clothing. Thereby, the signal clothing 1 and the second corresponding signal clothing are essentially synchronized in terms of signal generation.

Accordingly, the signal clothing 1 can transmit the synchronization signal to enable the first corresponding signal clothing to generate the corresponding signal synchronously. In addition, the signal clothing 1 can receive another synchronization signal from the second corresponding signal clothing to generate a signal synchronously with the second corresponding signal clothing. Therefore, the signal clothing 1, the first corresponding signal clothing, and the second corresponding signal clothing are essentially synchronized in terms of signal generation after a period of time.

It should be noted that the signal clothing 1, the first corresponding signal clothing, and the second corresponding signal clothing described above can perform identical functions. In addition, the signal clothing 1, the first corresponding signal clothing, and the second corresponding signal clothing are named differently (i.e., the name of the first corresponding signal clothing begins with “the first corresponding” and the name of the second corresponding signal clothing begins with “the second corresponding”) because it is easier to explain the interactions between them. Additionally, the transceiving unit 15 of the signal clothing 1 may be provided with only one of transmitting function and receiving a synchronization signal. If the transceiving unit 15 of the signal clothing is only provided with the transmitting function, it means that it is only configured to enable other signal clothing to be synchronized with it. Conversely, if the transceiving unit 15 of the signal clothing is only provided with the receiving function, it means that it is only configured to be synchronized by other signal clothing.

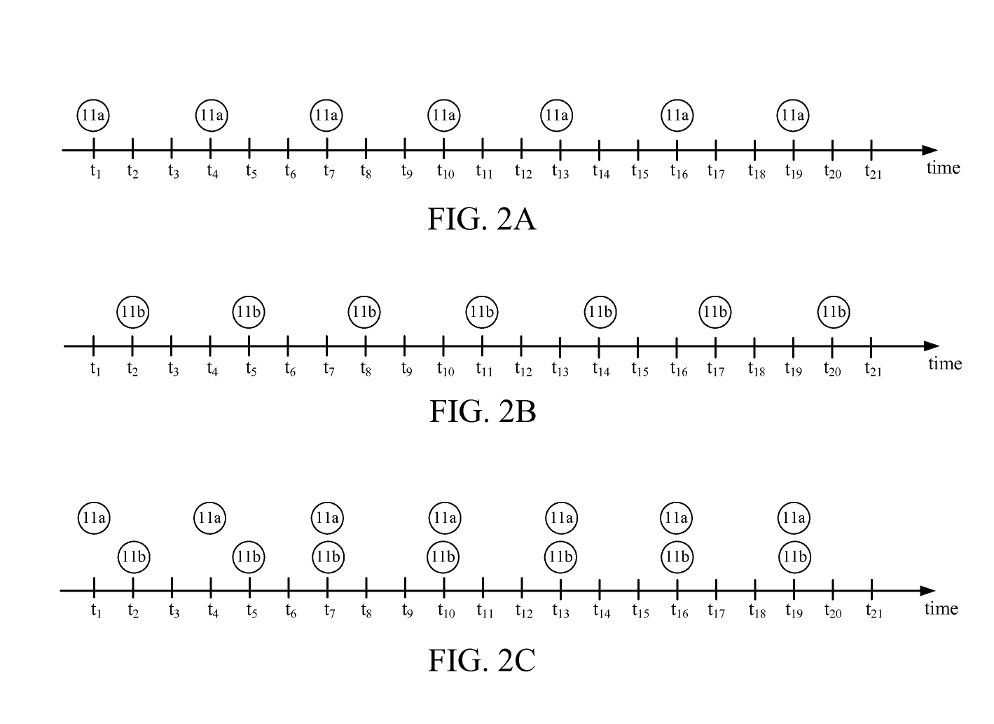

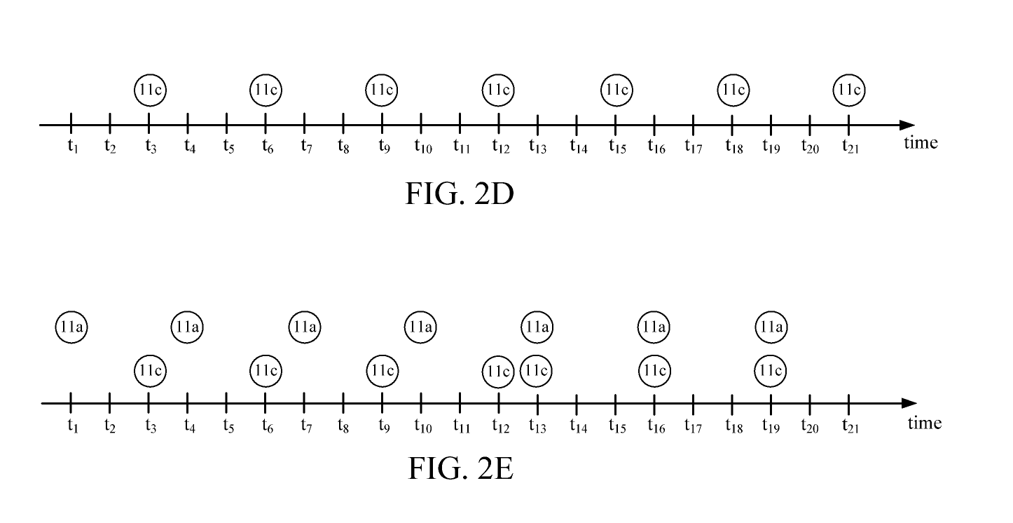

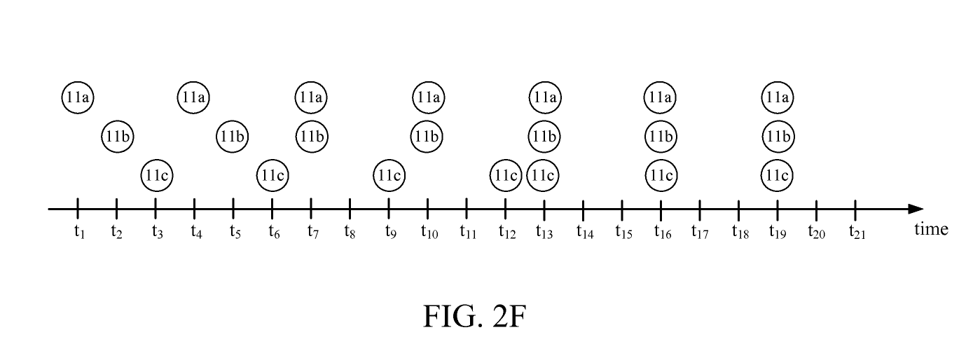

From the descriptions below, practical operations of the signal clothing of the present invention can be appreciated by people skilled in the art. Please refer to FIGS. 2A and 2B, wherein FIG. 2A depicts signals 11a generated by a first signal clothing at different time points in a first operating frequency, and FIG. 2B depicts signals 11b generated by a second signal clothing at different time points in a second operating frequency. It should be particularly noted that elements of the first signal clothing and the second signal clothing described herein are the same as and perform the same functions as those of the signal clothing 1. That is, the first signal clothing and second signal clothing individually comprise a clothing body, a signal generating unit, and a transceiving unit respectively. As can be seen in FIGS. 2A and 2B, the first signal clothing and the second signal clothing generate the signals 11a and the signals 11b respectively in the same operating frequency (i.e., the first operating frequency and the second operating frequency are the same) but at different starting time points, so the signals 11a and 11b are not synchronized with each other.

As shown in FIG. 2C, assume that the first signal clothing and the second signal clothing are moving close to each other. Assume that the first signal clothing and the second signal clothing are close enough at a time point t7, which means that the first signal clothing and the second signal clothing are within signal coverage of each other at a time point t7. In case that the signal generating unit of the first signal clothing happens to generate a signal 11a at this time point (i.e., the time point t7), the transceiving unit of the first signal clothing transmits a first synchronization signal in response to the signal 11a generated at the time point t7. Then, the transceiving unit of the second signal clothing receives the first synchronization signal and generates a signal 11b immediately in response to the receiving of the first synchronization signal. Since all these operations (from generation of the signal 11a by the first signal clothing at the time point t7 to generation of the signal 11b by the second signal clothing at the time point t7) happen within a very short time period, so it is said that all happen at the time point t7. After the time point t7, the second signal clothing generates the signals 11b periodically in a second operating frequency that is equal to the first operating frequency.

After generating the signal 11b at the time point t5, the second signal clothing would generate next signal 11b at the time point t8 originally; however, generation of the next signal 11b by the second signal clothing is advanced to the time point t7 because the first signal clothing and the second signal clothing are close enough (i.e. the first signal clothing and the second signal clothing are within a signal coverage of each other) at the time point t7. Consequently, signal generations by the first signal clothing and the second signal clothing are synchronized. It should be noted that, in this example, the period in which the synchronization signal is transmitted is twice of the period in which the signal clothing generates the signal, i.e., the synchronization signal is transmitted once every two generations of the signal.

Additionally, it is assumed that a third signal clothing is also moving close to the first signal clothing. Elements of the third signal clothing are the same as those of the signal clothing 1, i.e., include a clothing body, a signal generating unit, and a transceiving unit. The third signal clothing generates a signal 11c periodically in a third operating frequency, as shown in FIG. 2D. The third operating frequency is equal to the first operating frequency and the second operating frequency described above, so the only difference between the signals 11c, the signals 11a, and the signals 11b lies in the starting time points of signal generation.

Assume that the first signal clothing and the third signal clothing are close enough at the time point t13, which means that the first signal clothing and the third signal clothing are now within signal coverage of each other. At this time point, the signal generating unit of the first signal clothing generates a signal 11a and the transceiving unit of the first signal clothing generates a synchronization signal immediately in response to the signal 11a. After receiving the synchronization signal, the third signal clothing generates a signal 11c immediately at the time point t13. Similarly, these operations (from generation of the signal 11a by the first signal clothing at the time point t13 to generation of the signal 11c by the third signal clothing at the time point t13) all happen within a very short time period, so it is said that all happen at the time point t13. After the time point t13, the signal generating unit of the third signal clothing generates the signals 11c periodically in the third operating frequency. Consequently, the first signal clothing and the third signal clothing are synchronized in terms of signal generation. FIG. 2E depicts a schematic view of signals generated by the first signal clothing and third signal clothing, including both signals generated prior to the synchronization (before the time point t13) and signals generated after the synchronization (after the time point t13).

It is possible that the third signal clothing generates the signals 11c synchronously after receiving the second synchronization signal transmitted by the second signal clothing, when the second signal clothing and the third signal clothing are close to each other. Therefore, when the first signal clothing, the second signal clothing, and the third signal clothing are close enough, synchronization in terms of signal generation will be achieved between them as shown in FIG. 2F. Additionally, the signal clothing that received a synchronization signal at first is synchronized by another signal clothing that transmitted the synchronization signal, so there exists no master-slave relationship between the signal clothing, and the synchronization relationships between each other depend on the time sequence in which they receive the synchronization signals.

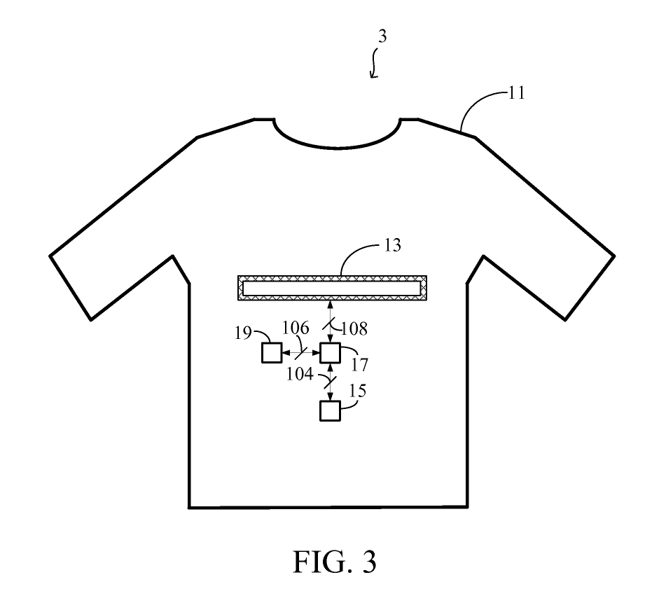

A second example embodiment of the present invention is depicted in FIG. 3, which is a schematic view of a signal clothing 3. Like the signal clothing 1, the signal clothing 3 also comprises a clothing body, a signal generating unit, and a transceiving unit and all of them operate in the same way as those of the signal clothing 1. Difference from the signal clothing 1 lies in that the signal clothing 3 has a first priority order 106, which is carried by the synchronization signal transmitted by the transceiving unit of the signal clothing 3. Accordingly, when a first corresponding signal clothing having a second priority order receives the synchronization signal, it is determined whether the second priority order is higher than the first priority order. Only when the second priority order is lower than the first priority order, the first corresponding signal cloth will generate a corresponding signal synchronously.

Furthermore, the signal clothing 3 further comprises a determination unit 17 and a storage unit 19, wherein the storage unit 19 stores the first priority order 106. After the transceiving unit 15 of the signal clothing 3 receives another synchronization signal carrying a third priority order 104 from the second corresponding signal clothing having the third priority order 104, the transceiving unit 15 of the signal clothing 3 retrieves the third priority order 104 from the another synchronization signal and transmits it to the determination unit 17. Then, the determination unit 17 determines whether the first priority order 106 stored in the storage unit 19 is lower than the third priority order 104. If the first priority order 106 is lower than or equal to the third priority order 104, then the determination unit 17 transmits a triggering signal 108 to the signal generating unit 13 so that the signal generating unit 13 generates a signal in response to the triggering signal 108. As a result, the signal clothing 3 and the second corresponding signal clothing are synchronized in terms of signal generation. However, if the first priority order 106 is not lower than the third priority order 104, then the determination unit 17 will not transmit any signal to the signal generating unit 13, so the signal generating unit 13 generates the signals in the its original operating frequency.

Briefly speaking, the difference of the first embodiment lies in that the signal clothing 3, the first corresponding signal clothing, and the second corresponding signal clothing in the second embodiment individually have a priority order, and synchronization depends on the priority orders of the signal clothing. That is, a signal clothing having a higher priority order is configured to synchronize other signal clothing having lower priority orders; signal clothing having lower priority orders can only be synchronized by a signal clothing having a higher priority order. Additionally, operations between signal clothing having the same priority orders are just as described in the first embodiment and, thus, will not be further described herein.

A third example embodiment of the present invention is also as depicted in FIG. 3. The third embodiment differs from the second embodiment in that the storage unit 19 in the third embodiment is stored with individual priority orders 106 (e.g., the first priority order, the second priority order, and the third priority order) and their corresponding operating frequencies 110, so the triggering signal 108 transmitted by the determination unit 17 to the signal generation unit 13 carries the corresponding operating frequency of the third priority order. After receiving the triggering signal 108, the signal generating unit 13 not only generates the signal in response to the triggering signal 108, but also generates the signal periodically in the operating frequency 110 corresponding to the third priority order thereafter.

Accordingly, in the third embodiment, by storing the operating frequencies corresponding to the priority orders in the storage unit 19, the operating frequency 110 corresponding to the third priority order can be obtained. Hence, by means of what described in the third embodiment, even if the first operating frequency, the second operating frequency, and the third operating frequency are different from each other, the signal clothing can still change the original operating frequency according to the operating frequency corresponding to the priority order, thereby achieving synchronization.

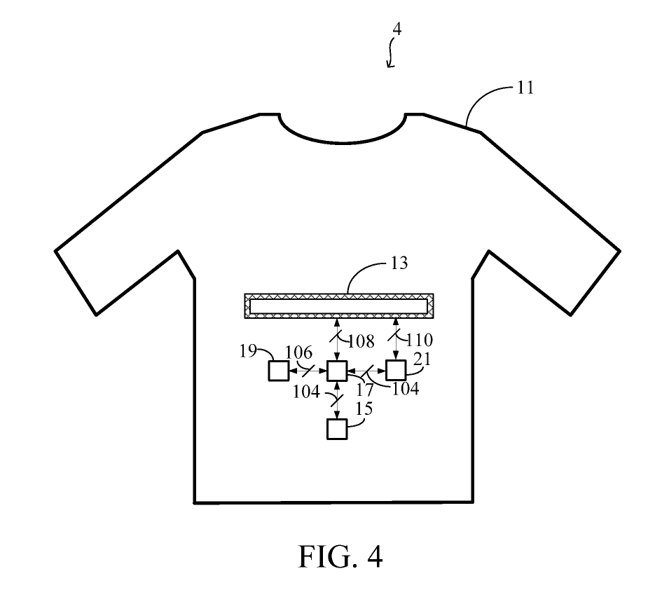

A fourth example embodiment is depicted in FIG. 4, which is a schematic view of a signal clothing 4 of the present invention. The signal clothing 4 is different from that in the third embodiment in that the signal clothing 4 further comprises a calculation unit 21 configured to calculate the operating frequency 110 corresponding to the third priority order according to the another synchronization signal that is periodically received. In this embodiment, the first operating frequency, the second operating frequency, and the third operating frequency may be different from each other; however the period in which the synchronization signal is transmitted must be equal to that generated by the signal clothing, i.e., a synchronization signal must be transmitted each time a signal is generated. In this way, the calculation unit 21 can calculate the operating frequency 110 corresponding to the third priority order and then transmit the operating frequency 110 to the signal generating unit 13 so that the signal generating unit 13 generates the signal periodically according to the operating frequency 110 corresponding to the third priority order.

Besides, in the second embodiment, the third embodiment, and the fourth embodiment, the storage unit 19 may also be configured to store a group code, and the another synchronization signal may carry a group code of the second corresponding signal clothing. After receiving the another synchronization signal from the second corresponding signal clothing, the transceiving unit 15 of the signal clothing 2, 3, or 4 retrieves the group code of the second corresponding signal clothing from the another synchronization signal and transmits it to the determination unit 17. Then, the determination unit 17 determines whether the group code of the second corresponding signal clothing is identical to that stored in the storage unit 19. If the group code of the second corresponding signal clothing is identical to that stored in the storage unit 19 (i.e., the signal clothing 2, 3 or 4 belongs to the same group as the second corresponding signal clothing), then the determination unit 17 transmits a triggering signal 108 to the signal generating unit 13 so that the signal generating unit 13 generates the signal in response to the triggering signal 108. Thus, as the signal clothing 2, 3 or 4 belongs to the same group as the second corresponding signal clothing, synchronization in signal generation is achieved between each other.

Conversely, if the group code of the second corresponding signal clothing is not identical to that stored in the storage unit 19 (i.e., the signal clothing 2, 3 or 4 does not belong to the same group as the second corresponding signal clothing), then the determination unit 17 will not transmit any signal to the signal generating unit 13, so the signal generating unit 13 generates the signals in the its original operating frequency.

It should be noted that, the storage unit 19 may store only the group codes and the synchronization signals may carry only the group codes of individual signal clothing. In other words, there may exist only the group relationships but no priority orders among the signal clothing, in which case synchronization in signal generation only depends on whether the signal clothing are in the same group.

According to the above descriptions, several pieces of signal clothing worn on different persons can generate an audio or flashing signal synchronously through periodical receptions and transmissions of synchronization signals, when these pieces of signal clothing are close enough. Hence, by means of the signal clothing of the present invention, synchronization in signal generation can be achieved among objects or users wearing such signal clothing. Moreover, when a lot of objects or users are all wearing the signal clothing of the present invention, an effect of synchronized lighting or sound can be delivered.

The present invention may be embodied in other specific forms without departing from the spirit or essential attributes thereof, and it is, therefore, desired that the present disclosure and embodiments be considered in all respects as illustrative and not restrictive. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A signal clothing, comprising:
a clothing body;
a signal generating unit disposed on the clothing body, being configured to generate a signal periodically; and
a transceiving unit disposed on the clothing body and electrically connected to the signal generating unit, being configured to transmit a synchronization signal periodically in response to the signal periodically generated by the signal generating unit so that a corresponding signal clothing generates a corresponding signal synchronously after receiving the synchronization signal and then generates the corresponding signal periodically in an operating frequency.

2. The signal clothing of claim 1, wherein the signal clothing has a first priority order, which is carried by the synchronization signal.

3. The signal clothing of claim 2, wherein the corresponding signal clothing has a second priority order lower than the first priority order, the first priority order corresponds to the operating frequency, and the corresponding signal clothing generates the corresponding signal periodically in the operating frequency according to the second priority order that is lower than the first priority order.

4. The signal clothing of claim 2, wherein the transceiving unit is further configured to receive another synchronization signal from another corresponding signal clothing, and the signal generating unit is further configured to generate the signal periodically after receiving the another synchronization signal.

5. The signal clothing of claim 4, wherein the another corresponding signal clothing is configured to transmit the another synchronization signal periodically, and the transceiving unit is further configured to receive the another synchronization signal transmitted periodically by the another signal clothing, the signal clothing further comprising:
a calculation unit, being configured to calculate the operating frequency according to the another synchronization signal periodically received by the transceiving unit so that the signal generating unit generates the signal periodically according to the operating frequency.

6. The signal clothing of claim 4, wherein the another synchronization signal carries a third priority order of the another corresponding signal clothing, which is higher than the first priority order, the signal clothing further comprising:
a determination unit, being configured to determine that the first priority order is lower than the third priority order,
wherein the signal generating unit is configured to generate the signal synchronously according to the another synchronization signal if the determination unit determines that the first priority order is lower than the third priority order.

7. The signal clothing of claim 6, wherein the third priority order corresponds to the operating frequency, and the signal generating unit is configured to generate the signal periodically in the operating frequency according to the third priority order.

8. The signal clothing of claim 4, wherein the signal clothing has a group code, and the another synchronization signal carries a group code of the another corresponding signal clothing, the signal clothing further comprising:
a determination unit, being configured to determine that the group code of the signal clothing is identical to the group code of the another corresponding signal clothing so that the signal generating unit generates the signal periodically after receiving the another synchronization signal.

9. The signal clothing of claim 1, wherein the signal generating unit is a light source device, and the signal is a flashing signal generated by the light source device.

10. The signal clothing of claim 1, wherein the signal generating unit is an audio source device, and the signal is an audio signal generated by the audio source device.

11. A signal clothing, comprising:
a clothing body;
a transceiving unit disposed on the clothing body, being configured to receive a synchronization signal from a corresponding signal clothing; and
a signal generating unit disposed on the clothing body and electrically connected to the transceiving unit, being configured to generate a signal according to the synchronization signal, and being further configured to, after generating the signal, generate the signal periodically in an operating frequency.

12. The signal clothing of claim 11, wherein the signal generating unit is a light source device, and the signal is a flashing signal generated by the light source device.

13. The signal clothing of claim 11, wherein the signal generating unit is an audio source device, and the signal is an audio signal generated by the audio source device.

14. The signal clothing of claim 11, wherein the signal clothing has a first priority order, and the synchronization signal carries a second priority order of the corresponding signal clothing, the signal clothing further comprising:
a determination unit, being configured to determine that the first priority order is lower than the second priority order,
wherein the signal generating unit is configured to generate the signal synchronously according to the synchronization signal if the determination unit determines that the first priority order is lower than the second priority order.

15. The signal clothing of claim 14, wherein the second priority order corresponds to the operating frequency, and the signal generating unit is configured to generate the signal periodically in the operating frequency according to the second priority order.

16. The signal clothing of claim 11, wherein the signal clothing has a group code, and the synchronization signal carries a group code of the corresponding signal clothing, the signal clothing further comprising:
a determination unit, being configured to determine that the group code of the signal clothing is identical to the group code of the corresponding signal clothing so that the signal generating unit generates the signal periodically after receiving the synchronization signal.

17. The signal clothing of claim 11, wherein the corresponding signal clothing is configured to transmit the synchronization signal periodically, and the transceiving unit is configured to receive the synchronization signal transmitted periodically by the corresponding signal clothing, the signal clothing further comprising:
a calculation unit, being configured to calculate the operating frequency according to the synchronization signal periodically received by the transceiving unit so that the signal generating unit generates the signal periodically according to the operating frequency.
